(19) United States
(12) Patent Application Publication
(10) Pub. No.: US 2025/0265348 A1
(43) Pub. Date: Aug. 21, 2025

(54) CYBERSECUITY TESTING BY FORCING RECOVERY PATHS

(71) Applicant: International Business Machines Corporation, Armonk, NY (US)

(72) Inventors: Michael Page Kasper, Wappingers Falls, NY (US); Joshua David Steen, Fishkill, NY (US); Diane Marie Stamboni, POUGHKEEPSIE, NY (US)

(21) Appl. No.: 18/444,875

(22) Filed: Feb. 19, 2024

(51) Int. Cl. G06F 21/57; G06F 11/07; G06F 11/14; G06F 11/36

(52) U.S. Cl. CPC G06F 21/577; G06F 11/0787; G06F 11/1402; G06F 11/3688

(57) ABSTRACT

A technique of testing recovery paths for potential security vulnerabilities includes a processor executing a code testing service and a program under test. The code testing service forces a recovery path in the program under test, and the program under test causes program checks. The operating system creates notifications regarding the program checks. The processor processes the notifications utilizing a code monitor to detect potential security vulnerabilities in the recovery path of the program under test. The code monitor generates and stores a report of the potential security vulnerabilities in the program under test.

### BACKGROUND OF THE INVENTION

The present invention relates in general to data processing, and more specifically, to cybersecurity techniques. Still more particularly, the present invention relates to cybersecurity testing techniques that force recovery paths to enable vulnerability testing of the recovery paths.

Software programmers and testers often exercise the main execution paths of software code in various different ways to test the code for security vulnerabilities. However, error recovery paths, which are taken only by a program while recovering from errors, can be overlooked. The present application recognizes that because errors can often be caused or observed by unauthorized users, recovery paths should also be tested for security vulnerabilities.

### SUMMARY OF THE INVENTION

In at least one embodiment, a technique of testing recovery paths for potential security vulnerabilities includes a processor executing a code testing service and a program under test. The code testing service forces a recovery path in the program under test, and the program under test causes program checks. The operating system creates notifications regarding the program checks. The processor processes the notifications utilizing a code monitor to detect potential security vulnerabilities in the recovery path of the program under test. The code monitor generates and stores a report of the potential security vulnerabilities in the program under test.

### BRIEF DESCRIPTION OF THE DRAWINGS

FIG. 1 is a high-level block diagram of an exemplary data processing environment in accordance with one or more embodiments;

FIG. 2 is a high-level block diagram of an exemplary software architecture in accordance with one or more embodiments;

FIG. 3 is a high-level block diagram of an exemplary data configuration of a code testing service suitable for interactive testing in accordance with one or more embodiments;

FIG. 4 is a high-level block diagram of an exemplary data configuration of a code testing service suitable for dynamic testing in accordance with one or more embodiments;

FIG. 5 is a high-level block diagram of an exemplary process of interactive testing of recovery paths of software code in accordance with one or more embodiments; and

FIG. 6 is a high-level block diagram of an exemplary process of dynamic testing of recovery paths of software code in accordance with one or more embodiments.

In accordance with common practice, various features illustrated in the drawings may not be drawn to scale. Accordingly, dimensions of the various features may be arbitrarily expanded or reduced for clarity. In addition, some of the drawings may not depict all of the components of a given system, method, or device. Finally, like reference numerals may be used to denote like or corresponding features in the specification and figures.

### DETAILED DESCRIPTION OF ILLUSTRATIVE EMBODIMENT

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code testing service 150, programs under test 152, and authorized code monitor (ACM) 154. In addition, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code testing service 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

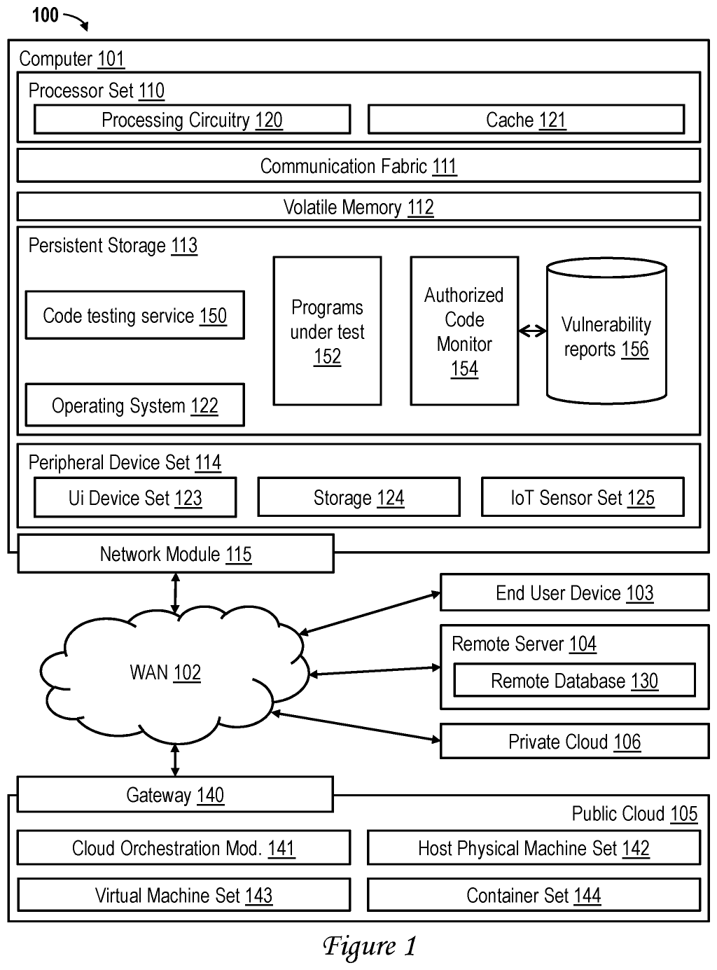

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one or more computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be implemented in code testing service 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet-of-Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the Internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the Internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Those of ordinary skill in the art will appreciate that the architecture and components of a data processing environment can vary between embodiments. Accordingly, the exemplary computing environment 100 given in FIG. 1 is not meant to imply architectural limitations with respect to the claimed invention.

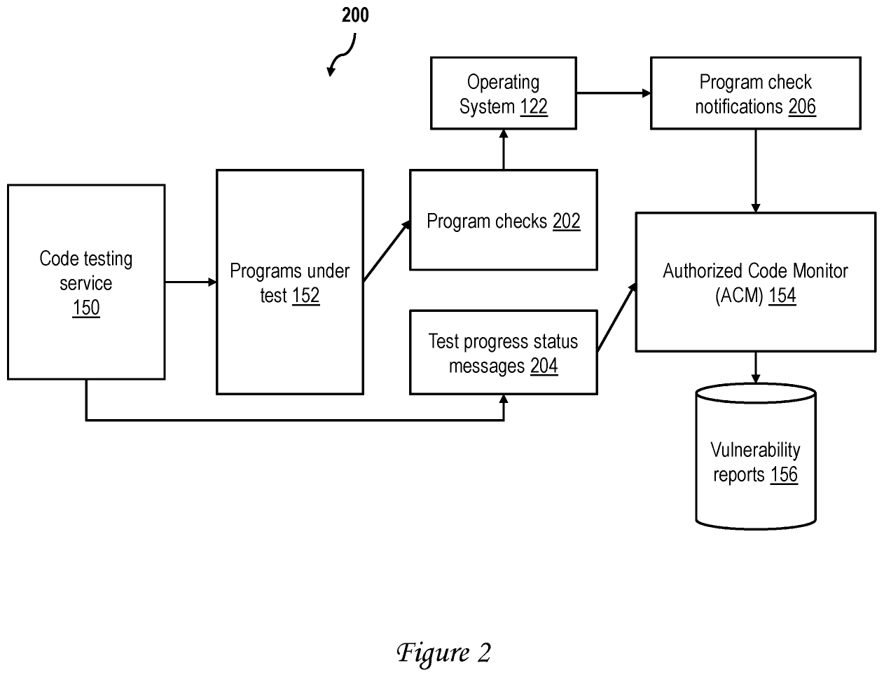

Referring now to FIG. 2, there is a high-level block diagram of an exemplary software architecture 200 in accordance with one or more embodiments. In this example, code testing service 150 exercises one or more programs under test 152 in order to detect potential security vulnerabilities. In accordance with one or more embodiments, the testing performed by code testing service 150 includes exploring recovery paths of programs under test 152.

In some embodiments, the testing performed by code testing service 150 includes interactive testing in which a human agent or digital (e.g., programmatic or artificial intelligence (AI)) agent injects commands into the system to force a program under test 152 to take a recovery path. For example, in an embodiment in which operating system 122 is z/OS, these commands can include, for example, CANCEL commands, FORCE commands, and/or SLIP (serviceability level indication processing) commands. A CANCEL command can be utilized to cancel a job in execution, an inter-program communication facility, or a started task. A SLIP command controls operation of the SLIP facility, which is a diagnostic aid that intercepts or traps certain system events (hardware and/or software) and specifies what action to take (e.g., attempted recovery, memory dump, etc.).

In some embodiments, the testing performed by code testing service 150 alternatively or additionally includes dynamic testing in which code testing service 150 automatically disrupts (e.g., interrupts) a target program under test 152 invoked by a legal call. As described further below, with z/OS the dynamic testing can determine to interrupt the target program under test 152 utilizing or based on an instruction (e.g., supervisor call (SVC) instruction), a program call (PC), or an authorization code (AC) (e.g., priority) with AC(1) specifying the modules that can use restricted system services and resources.

The testing performed by code testing service 150 on programs under test 152 causes programs under test 152 to generate a program check 202 for an error recovery path taken. For each program check operating system 122 generates a notification 206 preferably identifying (e.g., utilizing an abend (abnormal ending) code or the like) the cause of program under test 152 taking a given error recovery path. Notifications of program checks 206 are received and processed by authorized code monitor (ACM) 154 in order to detect and report security vulnerabilities in programs under test 152. In some examples, ACM 154 can be implemented with z/OS Authorized Code Monitor, available from International Business Machines Corporation of Armonk, New York. Code testing service 150 additionally provides test status progress messages 204 to ACM 154 to enable ACM 154 to correlate program check notifications 206 with particular interactive and/or dynamic tests of programs under test 152. Based on its processing of program checks and notifications 200, ACM 154 generates vulnerability reports 156 identifying potential security vulnerabilities in programs under test 152, including potential security vulnerabilities in the recovery paths of programs under test 152 forced by code testing service 150.

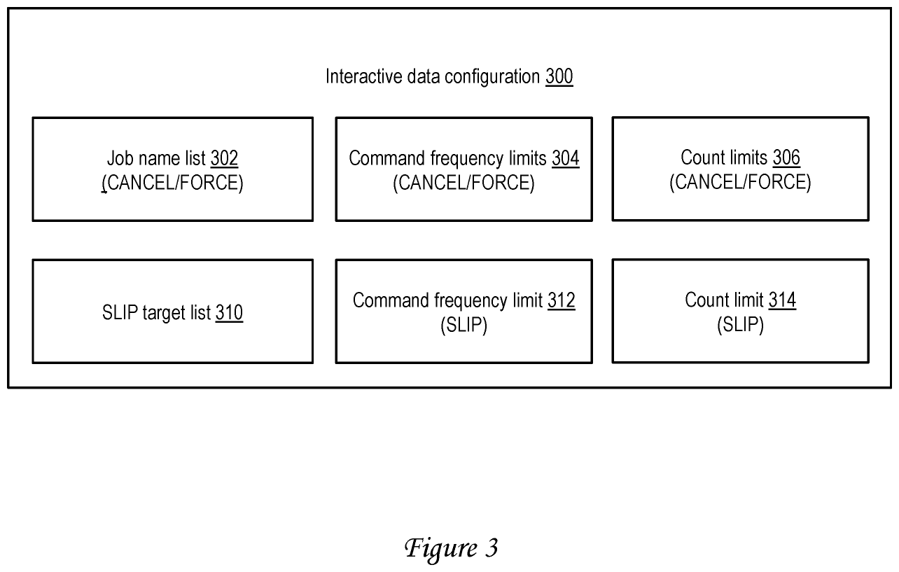

With reference now to FIG. 3, there is illustrated a high-level block diagram of an exemplary interactive data configuration 300 of a code testing service 150 suitable for interactive testing in accordance with one or more embodiments. In the depicted example, data configuration 300 includes a job name list 302 that filters running jobs to identify the job(s) (workloads) of programs under test 152 to be targeted by CANCEL and/or FORCE commands. In various implementations, job name list 302 can be specified, for example, by inclusion (i.e., explicitly enumerating job names to be tested) and/or exclusion (i.e., indicating job names to be tested by explicitly enumerating job names that are not to be tested). Further job name list 302 can specifying job names utilizing logical expressions, including those using wildcarding. Interactive data configuration 300 additionally includes command frequency limits 304 specifying a maximum frequency of issuance of CANCEL and/or FORCE commands by code testing service 150 and count limits 306 specifying a maximum number of CANCEL and/or FORCE commands issued by code testing service 150.

In order to support use of SLIP commands in interactive testing, interactive data configuration 300 additionally includes SLIP target list 310, which specify module names and/or job names for which code testing service 150 is to force recovery utilizing SLIP commands. Like job name list 302, SLIP target list 310 can specify module and job names, for example, utilizing inclusion, exclusion, and/or logical expressions. Interactive data configuration 300 additionally includes a command frequency limit 312 specifying a maximum frequency of issuance of SLIP commands by code testing service 150 and a count limit 314 specifying a maximum number of SLIP commands issued by code testing service 150. In some embodiments, count limits 306, 314 can be expressed as a count limits within a particular period of time, after which testing is again automatically performed by code testing service 150 in accordance with a periodic schedule (e.g., daily, weekly, monthly, etc.).

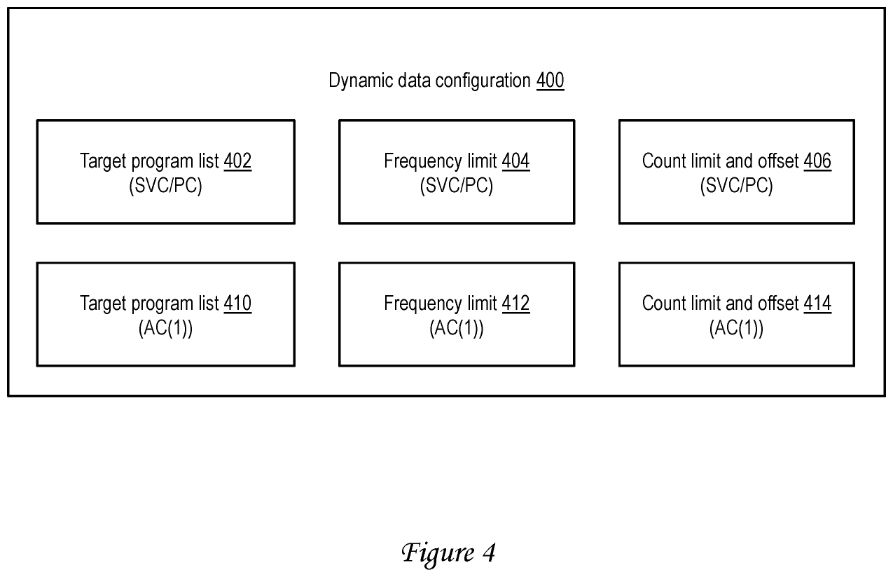

Referring now to FIG. 4, there is depicted a high-level block diagram of an exemplary dynamic data configuration 400 of a code testing service 150 suitable for dynamic testing in accordance with one or more embodiments. In this example, data configuration 400 includes a target program list 302 that filters programs under test 152 to be interrupted after being invoked by a proper call (e.g., a SVC instruction or program call (PC)). In various implementations, target program list 402 can be specified, for example, by inclusion (i.e., explicitly enumerating target programs to be tested) and/or exclusion (i.e., indicating programs to be tested by explicitly enumerating those to not be tested). Further target program list 402 can specifying target programs among programs under test 152 utilizing logical expressions, including those using wildcarding. Dynamic data configuration 400 additionally includes a frequency limit 404 specifying a maximum frequency of interruption of program invocations by code testing service 150 and count limit and offset 406 specifying a maximum number of interruptions of program invocations by code testing service 150 and a maximum offset within the interrupted program (e.g., in terms of instructions and/or processor cycles) at which interruption is permitted.

In order to support interruption based on authorization code, dynamic data configuration 400 additionally includes target program list 410, which specifies programs code testing service 150 is to interrupt based on their associated authorization code (or security/priority level). Like target program list 402, target program list 410 can specify target program list 410, for example, utilizing inclusion, exclusion, and/or logical expressions. Dynamic data configuration 400 additionally includes a frequency limit 412 specifying a maximum frequency of interruption of program invocations by code testing service 150 based on authorization code and a count limit and offset 406 specifying a maximum number of interruptions of program invocations by code testing service 150 based on authorization code and a maximum offset within the interrupted program (e.g., in terms of instructions and/or processor cycles) at which interruption is permitted. In some embodiments, count limits 406, 414 can be expressed as a count limits within a particular period of time, after which testing is again automatically performed by code testing service 150 in accordance with a periodic schedule (e.g., daily, weekly, monthly, etc.).

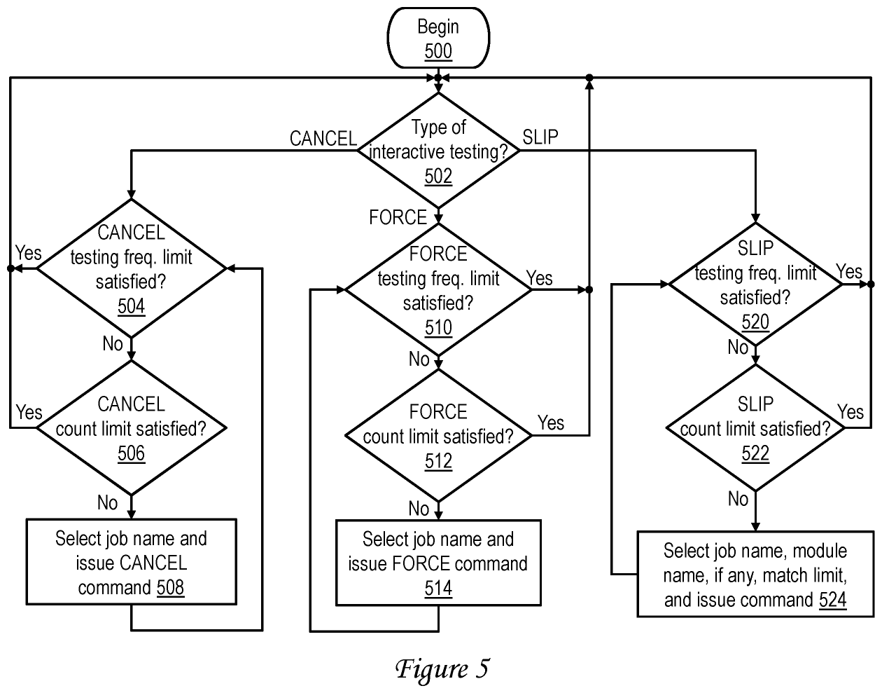

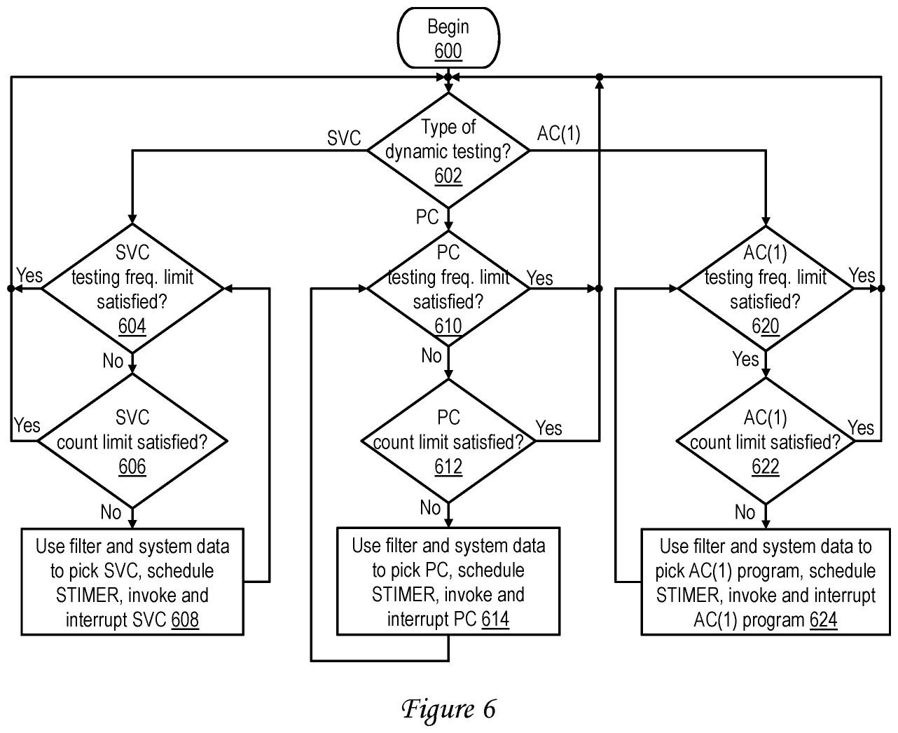

With reference now to FIG. 5, there is illustrated a high-level logical flowchart of an exemplary process of interactive testing of recovery paths of software code in accordance with one or more embodiments. The exemplary process can be performed, for example, through execution, by processing circuitry 120, of code testing service 150 to test recovery paths of one or more programs under test 152 for security vulnerabilities. In some embodiments or use cases, code testing service 150 can perform one or more of the interactive tests shown in FIG. 5 in parallel with one another and/or with the dynamic testing depicted in FIG. 6.

The process of FIG. 5 begins at block 500 and then proceeds to block 502, which illustrates a determination of a type of command issued by code testing service 150 to interrupt execution by computer 101 of a program under test 152. In one embodiment, these commands can include, for example, a CANCEL command, a FORCE command, and a SLIP command. These interrupt-initiating commands can be originated, for example, in response to an input by a human operator stationed at computer 101 or another device in computing environment 100 or in response to command by a digital agent (e.g., a programmatic agent or AI agent) in communication with computer 100. Although block 502 illustrates a determination of a single type of interrupt-initiating command, those skilled in the art will appreciate that, in at least some embodiments, code testing service 150 can issue multiple of interrupt-initiating commands in a temporally overlapping manner.

In response to a determination at block 502 that the interrupt-initiating command is a CANCEL command, the process proceeds to block 504, which illustrates code testing service 150 determining whether or not the command frequency limit 304 for CANCEL commands has been satisfied. For example, code testing service 150 may determine that the relevant command frequency limit 304 has been reached if the code testing service 150 has issued CANCEL commands at least at a specified frequency within a given time period. In response to a determination that the command frequency limit 304 applicable to CANCEL commands has been satisfied, the process of FIG. 5 returns to block 502. If code testing service 150 makes a negative determination at block 504, code testing service 150 additionally determines whether or not a count limit 306 applicable to CANCEL commands has been satisfied (block 506). For example, code testing service 150 may determine that the relevant count limit 306 has been reached if the code testing service 150 has issued at least a specified number of CANCEL commands within a particular interval. In response to a determination that the count limit 306 applicable to CANCEL commands has been satisfied, the process of FIG. 5 returns to block 502. If, however, code testing service 150 makes a negative determination at block 506, code testing service 150 selects an applicable job name for the CANCEL command by reference to job name list 302 and issues a CANCEL command specifying the selected job name (block 508). The process thereafter returns to block 504 and proceeds iteratively.

Returning to block 502, in response to a determination that the interrupt-initiating command is a FORCE command, the process proceeds to block 510, which illustrates code testing service 150 determining whether or not the command frequency limit 304 for FORCE commands has been satisfied. For example, code testing service 150 may determine that the relevant command frequency limit 304 has been reached if the code testing service 150 has issued FORCE commands at least at a specified frequency within a given time period. In response to a determination that the command frequency limit 304 applicable to FORCE commands has been satisfied, the process of FIG. 5 returns to block 502. If code testing service 150 makes a negative determination at block 510, code testing service 150 additionally determines whether or not a count limit 306 applicable to FORCE commands has been satisfied (block 512). For example, code testing service 150 may determine that the relevant count limit 306 has been reached if the code testing service 150 has issued at least a specified number of FORCE commands within a particular interval. In response to a determination that the count limit 306 applicable to FORCE commands has been satisfied, the process of FIG. 5 returns to block 502. If, however, code testing service 150 makes a negative determination at block 512, code testing service 150 selects an applicable job name for the FORCE command by reference to job name list 302 and issues a FORCE command specifying the selected job name (block 514). The process thereafter returns to block 510 and proceeds iteratively.

Referring again to block 502, in response to a determination that the interrupt-initiating command is a SLIP command, the process proceeds to block 520, which illustrates code testing service 150 determining whether or not the command frequency limit 312 for SLIP commands has been satisfied. For example, code testing service 150 may determine that the relevant command frequency limit 312 has been reached if the code testing service 150 has issued SLIP commands at least at a specified frequency within a given time period. In response to a determination that the command frequency limit 312 applicable to SLIP commands has been satisfied, the process of FIG. 5 returns to block 502. If code testing service 150 makes a negative determination at block 520, code testing service 150 additionally determines whether or not a count limit 322 applicable to SLIP commands has been satisfied (block 522). For example, code testing service 150 may determine that the relevant count limit 314 has been reached if the code testing service 150 has issued at least a specified number of SLIP commands within a particular interval. In response to a determination that the count limit 322 applicable to SLIP commands has been satisfied, the process of FIG. 5 returns to block 502. If, however, code testing service 150 makes a negative determination at block 522, code testing service 150 selects an applicable job name (and module name, if applicable) for the SLIP command by reference to SLIP target list 310 and issues a SLIP command specifying the selected job name (block 524). The process thereafter returns to block 520 and proceeds iteratively.

Referring now to FIG. 6, there is depicted a high-level logical flowchart of an exemplary process of dynamic testing of recovery paths of software code in accordance with one or more embodiments. The exemplary process can be performed, for example, through execution, by processing circuitry 120, of code testing service 150 to test recovery paths of one or more programs under test 152 for security vulnerabilities. In some embodiments or use cases, code testing service 150 can perform one or more of the dynamic tests shown in FIG. 6 in parallel with one another and/or with the interactive testing illustrated in FIG. 5.

The process of FIG. 6 begins at block 600 and then proceeds to block 602, which illustrates a determination of a type of dynamic interruption implemented by code testing service 150 to interrupt execution by computer 101 of a target program under test 152. In the exemplary embodiment, code testing service 150 can dynamically interrupt execution of the target program under test which is an SVC, a PC, or an AC(1) program. Although block 602 illustrates a determination of a single type of interrupt initiation, those skilled in the art will appreciate that, in at least some embodiments, code testing service 150 can initiate multiple interrupts in a temporally overlapping manner.

In response to a determination at block 602 that the interrupt is to be initiated for a SVC program, the process proceeds to block 604, which illustrates code testing service 150 determining whether or not the frequency limit 404 for interrupts of SVCs has been satisfied. For example, code testing service 150 may determine that the relevant frequency limit 404 has been reached if the code testing service 150 has issued interrupts of SVCs at least at a specified frequency within a given time period. In response to a determination that the frequency limit 404 applicable to SVCs has been satisfied, the process of FIG. 6 returns to block 602. If code testing service 150 makes a negative determination at block 604, code testing service 150 additionally determines whether or not a count limit 406 applicable to interruption of SVCs has been satisfied (block 606). For example, code testing service 150 may determine that the relevant count limit 406 has been reached if the code testing service 150 has issued at least a specified number of interrupts of SVCs within a particular interval. In response to a determination that the count limit 406 applicable to SVCs has been satisfied, the process of FIG. 6 returns to block 602. If, however, code testing service 150 makes a negative determination at block 606, code testing service 150 selects the target program under test 152 (i.e., a SVC program) by reference to target program list 402, schedules the interrupt utilizing a system facility (e.g., a system timer (STIMER) facility provided by operating system 122), and invokes the SVC, which is interrupted based upon expiration of the timer (block 608). The number of instructions executed within the target program under test 152 prior to the interruption can be estimated by an offset specified in count limit and offset 406. The process thereafter returns to block 604 and proceeds iteratively.

Returning to block 602, in response to a determination that the interrupt is to be initiated for a PC program, the process proceeds to block 610, which illustrates code testing service 150 determining whether or not the frequency limit 404 for interrupts of PCs has been satisfied. For example, code testing service 150 may determine that the relevant frequency limit 404 has been reached if code testing service 150 has issued interrupts of PCs at least at a specified frequency within a given time period. In response to a determination that the frequency limit 404 applicable to PCs has been satisfied, the process of FIG. 6 returns to block 602. If code testing service 150 makes a negative determination at block 610, code testing service 150 additionally determines whether or not a count limit 406 applicable to interruption of PCs has been satisfied (block 612). For example, code testing service 150 may determine that the relevant count limit 406 has been reached if the code testing service 150 has issued at least a specified number of interrupts of PCs within a particular interval. In response to a determination that the count limit 406 applicable to PCs has been satisfied, the process of FIG. 6 returns to block 602. If, however, code testing service 150 makes a negative determination at block 612, code testing service 150 selects the target program under test 152 (i.e., a PC program) by reference to target program list 402, schedules the interrupt utilizing a system facility (e.g., a system timer (STIMER) facility provided by operating system 122), and invokes the PC program, which is interrupted based upon expiration of the timer (block 614). The number of instructions executed within the target program under test 152 prior to the interruption can be estimated by an offset specified in count limit and offset 406. The process thereafter returns to block 610 and proceeds iteratively.

Referring again to block 602, in response to a determination that the interrupt is to be initiated for an AC(1) program, the process proceeds to block 620, which illustrates code testing service 150 determining whether or not the frequency limit 412 for interrupts of AC(1) programs has been satisfied. For example, code testing service 150 may determine that the relevant frequency limit 312 has been reached if the code testing service 150 has initiated interrupts of AC(1) programs at least at a specified frequency within a given time period. In response to a determination that the frequency limit 412 applicable to interrupts of AC(1) programs has been satisfied, the process of FIG. 6 returns to block 602. If code testing service 150 makes a negative determination at block 620, code testing service 150 additionally determines whether or not a count limit 414 applicable to interrupts of AC(1) programs has been satisfied (block 622). For example, code testing service 150 may determine that the relevant count limit 414 has been reached if the code testing service 150 has initiated at least a specified number of interrupts of AC(1) programs within a particular time interval. In response to a determination that the count limit 414 applicable to interrupts of AC(1) programs has been satisfied, the process of FIG. 6 returns to block 602. If, however, code testing service 150 makes a negative determination at block 622, code testing service 150 selects the target program under test 152 to be interrupted (i.e., an AC(1) program) by reference to target program list 410, schedules the interrupt utilizing a system facility (e.g., a system timer (STIMER) facility provided by operating system 122), and invokes the AC(1) program, which is interrupted based upon expiration of the timer (block 624). The number of instructions executed within the target program under test 152 prior to the interruption can be estimated by an offset specified in count limit and offset 414. The process thereafter returns to block 620 and proceeds iteratively.

As has been described, a technique of testing recovery paths for potential security vulnerabilities includes a processor executing a code testing service and a program under test. The code testing service forces a recovery path in the program under test, and the program under test causes program checks. An operating system generates notifications regarding the program checks. The processor processes the notifications utilizing a code monitor to detect potential security vulnerabilities in the recovery path of the program under test. The code monitor generates and stores a report of the potential security vulnerabilities in the program under test.

The present invention may be implemented as a method, a system, and/or a computer program product. The computer program product may include a storage device having computer-readable program instructions (program code) thereon for causing a processor to carry out aspects of the present invention. As employed herein, a “storage device” is specifically defined to include only statutory articles of manufacture and to exclude signal media per se, transitory propagating signals per se, and energy per se.

Aspects of the present invention are described herein with reference to flowchart illustrations and/or block diagrams that illustrate the architecture, functionality, and operation of possible implementations of systems, methods, and computer program products according to various embodiments. It will be understood that each block of the block diagrams and/or flowcharts and combinations of blocks in the block diagrams and/or flowcharts can be implemented by special purpose hardware-based systems and/or program code that perform the specified functions. While the present invention has been particularly shown as described with reference to one or more preferred embodiments, it will be understood by those skilled in the art that various changes in form and detail may be made therein without departing from the spirit and scope of the invention.

The figures described above and the written description of specific structures and functions are not presented to limit the scope of what Applicants have invented or the scope of the appended claims. Rather, the figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms and that multiple of the disclosed embodiments can be combined. Lastly, the use of a singular term, such as, but not limited to, “a” is not intended as limiting of the number of items.

What is claimed is:

1. A method of data processing in a data processing system including a processor, the method comprising:
a processor executing a code testing service and a program under test, wherein the executing includes:
the code testing service forcing a recovery path in the program under test;
the program under test generating program checks, resulting in notifications of program checks regarding the recovery path;
the processor processing the notifications utilizing a code monitor to detect potential security vulnerabilities in the recovery path of the program under test; and
the code monitor generating and storing a report of the potential security vulnerabilities in the program under test.

2. The method of claim 1, wherein forcing the recovery path includes forcing the recovery path through execution of a command.

3. The method of claim 1, wherein forcing the recovery path includes forcing the recovery path through initiating an interrupt of the program under test.

4. The method of claim 3, further comprising initiating the interrupt based on expiration of a timer.

5. The method of claim 1, further comprising:
suspending the forcing of recovery paths in the program under test based on a testing frequency limit being satisfied.

6. The method of claim 1, further comprising:
suspending the forcing of recovery paths in the program under test based on a testing count limit being satisfied.

7. A program product, comprising:
a storage device; and
program code stored within the storage device and executable by processing circuitry of a data processing system to cause the data processing system to perform:
executing a code testing service and a program under test, wherein the executing includes:
the code testing service forcing a recovery path in the program under test;
the program under test generating program checks, resulting in notifications of program checks regarding the recovery path;
processing the notifications utilizing a code monitor to detect potential security vulnerabilities in the recovery path of the program under test; and
generating and storing a report of the potential security vulnerabilities in the program under test.

8. The program product of claim 7, wherein forcing the recovery path includes forcing the recovery path through execution of a command.

9. The program product of claim 7, wherein forcing the recovery path includes forcing the recovery path through initiating an interrupt of the program under test.

10. The program product of claim 9, wherein the program code is executable by the processing circuitry to cause the data processing system to perform:
initiating the interrupt based on expiration of a timer.

11. The program product of claim 7, wherein the program code is executable by the processing circuitry to cause the data processing system to perform:
suspending the forcing of recovery paths in the program under test based on a testing frequency limit being satisfied.

12. The program product of claim 7, wherein the program code is executable by the processing circuitry to cause the data processing system to perform:
suspending the forcing of recovery paths in the program under test based on a testing count limit being satisfied.

13. A data processing system, comprising:
processing circuitry;
a storage device communicatively coupled to the processing circuitry; and
program code stored within the storage device and executable by the processing circuitry of the data processing system to cause the data processing system to perform:
executing a code testing service and a program under test, wherein the executing includes:
the code testing service forcing a recovery path in the program under test, resulting in notifications of program checks regarding the recovery path;
processing the notifications utilizing a code monitor to detect potential security vulnerabilities in the recovery path of the program under test; and
generating and storing a report of the potential security vulnerabilities in the program under test.

14. The data processing system of claim 13, wherein forcing the recovery path includes forcing the recovery path through execution of a command.

15. The data processing system of claim 13, wherein forcing the recovery path includes forcing the recovery path through initiating an interrupt of the program under test.

16. The data processing system of claim 15, wherein the program code is executable by the processing circuitry to cause the data processing system to perform:
initiating the interrupt based on expiration of a timer.

17. The data processing system of claim 13, wherein the program code is executable by the processing circuitry to cause the data processing system to perform:
suspending the forcing of recovery paths in the program under test based on a testing frequency limit being satisfied.

18. The data processing system of claim 13, wherein the program code is executable by the processing circuitry to cause the data processing system to perform:
suspending the forcing of recovery paths in the program under test based on a testing count limit being satisfied.
